(19) United States
(12) Patent Application Publication
(10) Pub. No.: US 2014/0143526 A1
(43) Pub. Date: May 22, 2014

(54) Branch Prediction Gating

(71) Applicants: Polychronis Xekalakis, Barcelona (ES); Pedro Marcuello, Barcelona (ES); Fernando Latorre, Barcelona (ES); Franck Sala, Haifa (IL); Gershon Rubinstein, Haifa (IL)

(72) Inventors: Polychronis Xekalakis, Barcelona (ES); Pedro Marcuello, Barcelona (ES); Fernando Latorre, Barcelona (ES); Franck Sala, Haifa (IL); Gershon Rubinstein, Haifa (IL)

(21) Appl. No.: 13/682,157

(22) Filed: Nov. 20, 2012

(51) Int. Cl. G06F 9/38

(52) U.S. Cl. CPC G06F 9/38
USPC 712/239

(57) ABSTRACT

In one embodiment, a processor includes at least one execution unit. The processor also includes prediction gating logic coupled to the at least one execution unit. The prediction gating logic may be to, in response to a first prediction that a first branch is taken, obtain a distance value to a second branch using a target array, and gate a branch prediction unit for a number of instruction blocks equal to the distance value to the second branch. Other embodiments are described and claimed.

### BACKGROUND

Embodiments relate generally to branch prediction in computer processors.

Conventionally, program code executed by a processor will include branches, meaning conditional instructions that may cause the flow of execution to branch in one of two possible directions (e.g., an IF instruction). These two possible directions may be the “not taken branch” (i.e., processing continues in the next sequential portion of the code) and the “taken branch” (i.e., processing jumps to a different, non-sequential portion of the code).

A branch predictor is a circuit that tries to predict which way a branch will go before the actual direction of the branch has been determined. The predicted branch direction may then be used to fetch a set of instructions so that they can be staged for execution and/or speculatively executed before the branch has actually been evaluated. In this manner, the branch predictor may enable the processor pipeline to operate efficiently.

### BRIEF DESCRIPTION OF THE DRAWINGS

FIGS. 1A-1B are block diagrams of systems in accordance with one or more embodiments.

FIG. 2 is an example in accordance with one or more embodiments.

FIGS. 3A-3B are sequences in accordance with one or more embodiments.

FIG. 4 is a block diagram of a processor in accordance with an embodiment of the present invention.

FIG. 5 is a block diagram of a multi-domain processor in accordance with another embodiment of the present invention.

FIG. 6 is a block diagram of an embodiment of a processor including multiple cores is illustrated.

FIG. 7 is a block diagram of a system in accordance with an embodiment of the present invention.

### DETAILED DESCRIPTION

In accordance with some embodiments, gating of a branch prediction unit may be provided. In some embodiments, a distance between a first branch and a second branch may be determined using a distance counter. The distance value may be stored in a first branch entry of a target array. Subsequently, in response to a prediction for the first branch, the branch prediction unit may be gated until reaching the expected location of the second branch. Such gating may reduce the electrical power consumed by the branch prediction unit.

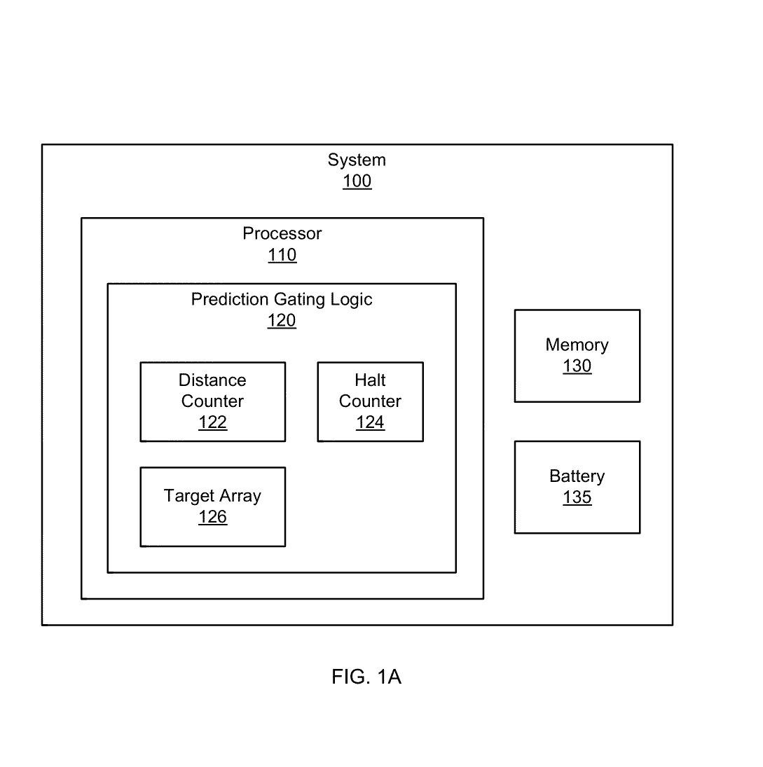

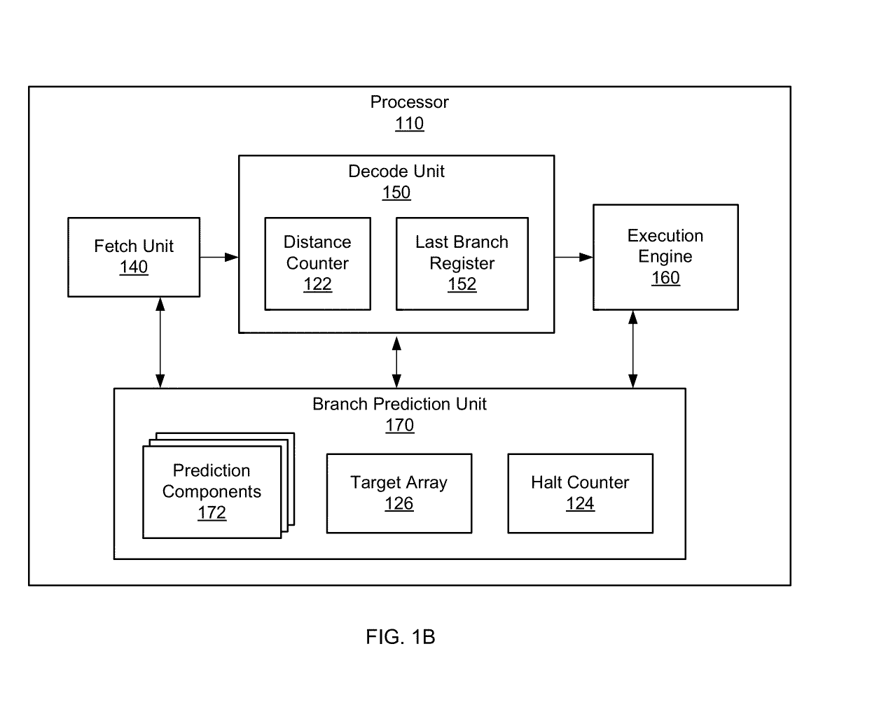

Referring to FIG. 1A, shown is a block diagram of a system 100 in accordance with one or more embodiments. As shown in FIG. 1A, the system 100 may include a processor 110, a memory 130, and a battery 135. In accordance with some embodiments, the system 100 may be all or a portion of any electronic device, such as a cellular telephone, a computer, a server, a media player, a network device, etc. In some embodiments, the battery 135 may be any electrical source or storage to power the system 100.

As shown, in one or more embodiments, the processor 110 may include prediction gating logic 120. In accordance with one or more embodiments, the prediction gating logic 120 may provide functionality to gate or control the use of branch predictions in the processor 110.

In one or more embodiments, the prediction gating logic 120 may operate in two phases, a training phase and a prediction phase. In the training phase, the prediction gating logic 120 may collect historical information about the distances (e.g., number of instruction blocks, number of instructions, etc.) between branches found in program code. Further, in the prediction phase, the prediction gating logic 120 may gate the branch prediction functionality of the processor 110 based on the historical branch information (gathered during the training phase).

As shown, in some embodiments, the prediction gating logic 120 may include a distance counter 122, a halt counter 124, and a target array 126. In some embodiments, the distance counter 122 may be used during the training phase to determine a distance between a first branch and a second branch. This distance is then stored in a first branch entry (i.e., an entry of the target array 126 corresponding to the first branch). During the prediction phase, the halt counter 124 may be set equal to the distance value when the first branch is predicted to be taken. Branch predictions may then be gated until the halt counter 124 reaches zero, indicating the expected location of the second branch. Thus, in some embodiments, the electrical power required for branch predictions may be reduced during the period in which a branch is not expected. In this manner, the power level of the battery 135 may be conserved.

The functionality of the prediction gating logic 120 is described in greater detail below with reference to FIGS. 1B, 2, and 3A-3B. In one or more embodiments, the prediction gating logic 120 may be implemented in any form of hardware, software, and/or firmware. For example, the prediction gating logic 120 may be implemented in microcode, programmable logic, hard-coded logic, control logic, instruction set architecture, processor abstraction layer, etc. Further, the prediction gating logic 120 may be implemented within the processor 110, and/or any other component accessible or medium readable by processor 110, such as memory 130. While shown as a particular implementation in the embodiment of FIG. 1A, the scope of the various embodiments discussed herein is not limited in this regard.

Referring now to FIG. 1B, shown is an example embodiment of the processor 110. As shown, in some embodiments, the processor 110 may include a fetch unit 140, a decode unit 150, an execution engine 160, and a branch prediction unit (BPU) 170. In one or more embodiments, the fetch unit 140 may retrieve program instructions from a cache or an external memory (e.g., memory 130 shown in FIG. 1A). The decode unit 150 may decode the retrieved instructions into microcode. Further, the execution engine 160 may execute the microcode. The BPU 170 may include functionality to predict branches in the program code.

As shown, in some embodiments, the BPU 170 includes prediction components 172, the target array 126, and the halt counter 124. Further, in some embodiments, the decode unit 150 may include the distance counter 122 and the last branch register 152. In one or more embodiments, the BPU 170 may use the various prediction components 172 (e.g., bimodal predictors, global predictors, local predictors, etc.) to generate different branch predictions, and may then select one of these predictions as being the most accurate and/or appropriate for use with the current branch. The BPU 170 may then use the selected prediction to determine the order in which the fetch unit 140 retrieves the instructions. In some embodiments, the particular prediction component 172 that provides the selected prediction may be referred to as the “preferred component” for the current branch.

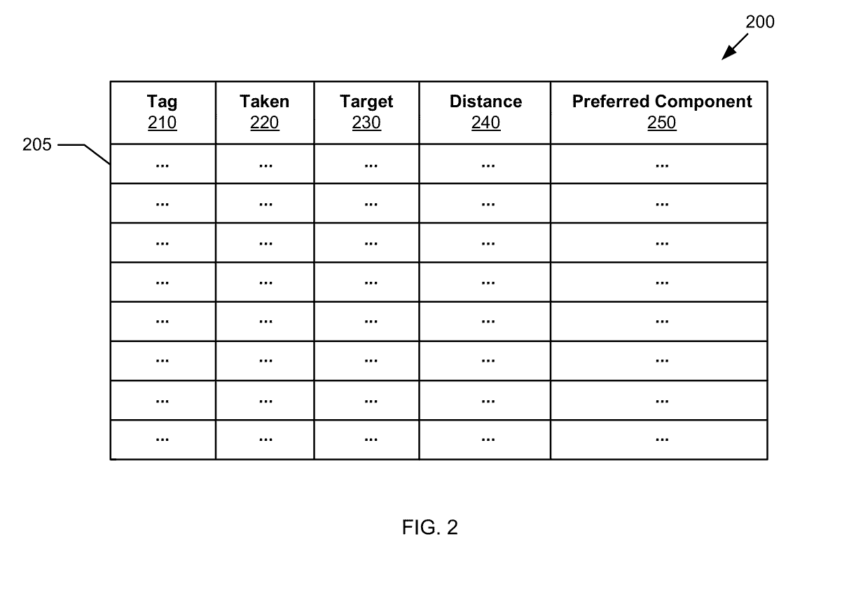

During the training phase, beginning when the BPU 170 predicts that a first branch is to be taken, the distance counter 122 may count up for each instruction block retrieved by the fetch unit 140. Further, in some embodiments, an identifier for the first branch may be stored in the last branch register 152. Subsequently, when the BPU 170 predicts that a second branch is to be taken, the value of the distance counter 122 may be used as the distance between the first branch and the second branch. In some embodiments, the target array 126 may be updated to include a first branch entry (i.e., an entry corresponding to the first branch). The first branch entry may include a distance portion to store the value of the distance counter 122. Further, the first branch entry may also include a tag portion to store the first branch identifier (e.g., obtained from the last branch register 152). Furthermore, the first branch entry may also include a preferred component portion to store an identifier for the prediction component 172 selected by the BPU 170 for the second branch prediction. An example embodiment of the target array 126 is described below with reference to FIG. 2.

During the prediction phase, when the BPU 170 again predicts that the first branch is to be taken, the halt counter 122 may be set equal to the distance value stored in the first branch entry of the target array 126. The halt counter 122 may then count down for each instruction block retrieved by the fetch unit 140. In one or more embodiments, the BPU 170 may be gated while the value of the halt counter 122 is greater than zero. Stated differently, until reaching the location of the second branch (as indicated by the halt counter 122 reaching zero), each instruction block is decoded and executed without performing a branch prediction. Accordingly, the electrical power required by the BPU 170 may be reduced or eliminated for processing the instruction blocks between the first and second branches.

When the value of the halt counter 122 reaches zero, the BPU 170 is no longer gated, and thus the BPU 170 may predict the second branch. In some embodiments, the BPU 170 may use only the prediction component 172 specified in the preferred component portion of the first branch entry of the target array 126. In this manner, the BPU 170 may avoid using other prediction components 172 to generate alternative predictions, and then selecting one of the alternative predictions. Accordingly, the electrical energy that would otherwise be required for generating and selecting such alternative predictions may be reduced or eliminated.

In one or more embodiments, all branch predictions are performed by the BPU 170. Alternatively, in some embodiments, branch predictions are divided between the BPU 170 and the decode unit 150. Specifically, the BPU 170 may provide predictions for direct branches, while the decode unit 150 may provide predictions for indirect branches. In such embodiments using divided branch predictions, the prediction gating logic 120 may set the distance value to a large number (e.g., 9999, 999999, etc.) when a direct branch is followed by an indirect branch in the training mode. Further, in the prediction mode, the halt counter 122 may be reset when the decode unit 150 provides a prediction for the indirect branch. Thus, in such embodiments, the BPU 170 is gated until the indirect branch is predicted.

Referring now to FIG. 2, shown is an example of the target array 126 in accordance with one or more embodiments. As shown, the target array 126 may include multiple entries 205, each corresponding to a different branch encountered during a training phase. In some embodiments, each entry 205 may include a tag portion 210, a taken portion 220, a target portion 230, a distance portion 240, and a preferred component portion 250.

In one or more embodiments, the tag portion 210 may include a tag identifier and/or an address for the current branch (i.e., the branch corresponding to the entry 205). In some embodiments, the tag identifier may be obtained from the last branch register 152 at the creation of the entry 205.

In some embodiments, the taken portion 220 may be an indication of whether the current branch has been predicted as taken. For example, the taken portion 220 may be a binary bit, a “yes/no” field, etc. Further, in some embodiments, the target portion 230 may include an identifier and/or address (e.g., an index and an offset) for the predicted target of the current branch.

In one or more embodiments, the distance portion 240 may include a distance value (e.g., a number of instruction blocks) from the current branch to the next branch. In some embodiments, the distance value stored in the distance portion 240 may be determined by the distance counter 122 (shown in FIG. 1A) during the training phase.

In some embodiments, the distance portion 240 may be an encoded version of the distance to the next branch. For example, assume that the distance portion 240 is configured to store a binary value in which each unit represents a distance of two instruction blocks. Assume further that the distance portion 240 of a given entry stores the binary value “10” (i.e., the decimal value “2”). Thus, in this example, the distance to the next branch may be decoded to be four instruction blocks. Optionally, in some embodiments, the decoded value of the distance portion 240 may be rounded down by one to account for odd distance values. In some embodiments, the encoding of the distance portion 240 may involve trimming one or more bits from a bit value of the distance to the next branch. Thus, in such embodiments, the number of bits required for the distance portion 240 may be reduced.

In one or more embodiments, the preferred component portion 250 may include an identifier for a prediction component used to predict the next branch (i.e., the branch located at the distance indicated by the distance portion 240). For example, the preferred component portion 250 may identify the prediction component 172 of the BPU 170 (shown in FIG. 1B) selected to predict a second branch.

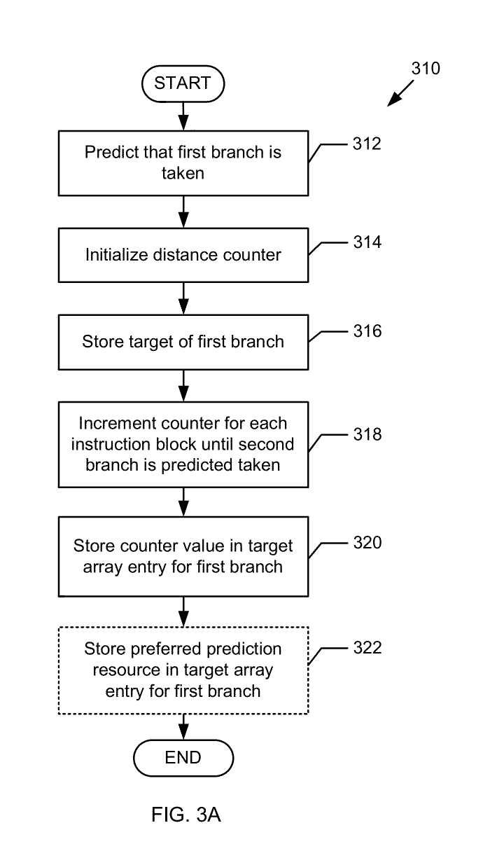

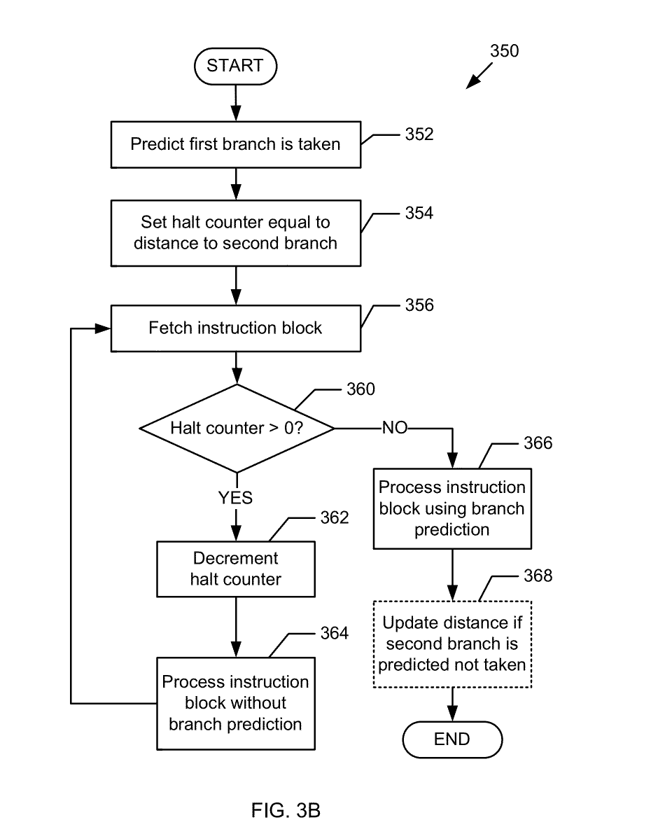

Referring now to FIG. 3A, shown is a sequence 310 for a training phase, in accordance with one or more embodiments. In one or more embodiments, the sequence 310 may be part of the prediction gating logic 120 shown in FIGS. 1A-1B. The sequence 310 may be implemented in hardware, software, and/or firmware. In firmware and software embodiments it may be implemented by computer executed instructions stored in a non-transitory computer readable medium, such as an optical, semiconductor, or magnetic storage device.

At step 312, a first branch is predicted taken. For example, referring to FIG. 1B, the BPU 170 may predict that a first branch (e.g., an IF instruction) will be taken when executed by the execution engine 160. In some embodiments, in response to the first branch being predicted taken, an entry corresponding to the first branch (e.g., entry 205 shown in FIG. 2) may be created in the target array 126.

At step 314, a distance counter is initialized. For example, referring to FIGS. 1A-1B, the distance counter 122 is set to zero in response to the first branch being predicted taken (at step 312). In some embodiments, the distance counter 122 may be included in the decode unit 150.

At step 316, the target of the first branch may be stored. For example, referring to FIGS. 1A-1B, the target of the first branch (e.g., predicted by the BPU 170) may be stored in the last branch register 152. In some embodiments, the last branch register 152 may be included in the decode unit 150.

At step 318, the distance counter may be incremented for each instruction block until a second branch is predicted taken. For example, referring to FIGS. 1A-1B, the distance counter 122 may be incremented by one for each instruction block until a second branch is predicted taken. In one or more embodiments, the prediction component 172 used to predict the second branch may be designated as the preferred component (i.e., the prediction component 172 determined to be most appropriate and/or accurate for predicting the second branch).

At step 320, the value of the distance counter may be stored in a target array entry for the first branch. For example, referring to FIGS. 1B and 2, the value of the distance counter 122 may be stored in the target array 126 in response to the second branch being predicted taken. In some embodiments, the value of the distance counter 122 may be stored in the distance portion 240 of the entry 205 (shown in FIG. 2).

At step 322, an identifier for the preferred component may optionally be stored in the target array entry for the first branch. For example, referring to FIGS. 1B and 2, an identifier for the prediction component 172 used to predict the second branch may be stored in the target array 126 in response to the second branch prediction. In some embodiments, this identifier may be stored in the preferred component portion 250 of the entry 205 (shown in FIG. 2). After step 322, the sequence 310 ends.

Referring now to FIG. 3B, shown is a sequence 350 for a prediction phase, in accordance with one or more embodiments. In one or more embodiments, the sequence 350 may be part of the prediction gating logic 120 shown in FIGS. 1A-1B. Further, in some embodiments, the sequence 350 may be subsequent to the sequence 310 shown in FIG. 3A. The sequence 350 may be implemented in hardware, software, and/or firmware. In firmware and software embodiments it may be implemented by computer executed instructions stored in a non-transitory computer readable medium, such as an optical, semiconductor, or magnetic storage device.

At step 352, a first branch is predicted taken. For example, referring to FIG. 1B, the BPU 170 may predict that a first branch will be taken when executed by the execution engine 160.

At step 354, a halt counter is set equal to the distance to the second branch. For example, referring to FIGS. 1B and 2, in response to the first branch being predicted taken (at step 352), the halt counter 124 may be set equal to a value for the distance between the first branch and the second branch. In some embodiments, the distance value may be obtained from the distance portion 240 included in a target array entry corresponding to the first branch (e.g., entry 205 of target array 126).

At step 356, an instruction block may be fetched. For example, referring to FIG. 1B, the fetch unit 140 may fetch an instruction block. At step 360, a determination about whether the halt counter is greater than zero is made. If so, then at step 362, the halt counter may be decremented by one.

At step 364, the instruction block (fetched at step 356) may be processed without using branch prediction. For example, referring to FIG. 1B, if the halt counter 124 is greater than zero, the current instruction block may be processed without using the BPU 170 to make a branch prediction for the current instruction block. After step 364, the sequence 350 may return to step 356 to fetch another instruction block.

Note that, in some embodiments, steps 356, 360, 362, and 364 form a loop that may be repeated for each of multiple instruction blocks while the halt counter is greater than zero. Note also that, because the BPU 170 is gated (i.e., not used) during each of these loops, the electrical energy that would otherwise be required to operate the BPU 170 is reduced or conserved during this period. Accordingly, embodiments may conserve at least some of the power of the battery 135 (shown in FIG. 1A).

Returning to step 360, if it is determined that the halt counter is not greater than zero, then at step 366, the current instruction block may be processed using branch prediction. For example, referring to FIG. 1B, if the halt counter 124 is equal to zero, the BPU 170 may be used to make a prediction for a second branch included in the current instruction block. In one or more embodiments, the BPU 170 may use only a preferred component (e.g., the prediction component 172 identified in the preferred component portion 250 of the target array 126) to generate the prediction for the second branch.

At step 368, the distance value may optionally be updated if the second branch is predicted not taken. For example, referring to FIGS. 1B-2, assume that the BPU 170 predicts with high confidence that the second branch is not taken (e.g., is predicted “strongly not taken”). In this situation, the distance portion 240 of the target array 126 may optionally be updated to a new distance value. For example, the distance portion 240 may be updated to include the distance from the first branch to a third branch (e.g., the next branch after the second branch). In some embodiments, the distance counter 122 may be used in a training phase to obtain the distance from the first branch to the third branch. After step 368, the sequence 350 ends.

Note that the examples shown in FIGS. 1A-1B, 2, and 3A-3B are provided for the sake of illustration, and are not intended to limit any embodiments. For instance, while embodiments may be shown in simplified form for the sake of clarity, embodiments may include any number and/or arrangement of processors, cores, and/or additional components (e.g., buses, storage media, connectors, power components, buffers, interfaces, etc.). In particular, it is contemplated that some embodiments may include any number of components other than those shown, and that different arrangement of the components shown may occur in certain implementations. Further, it is contemplated that specifics in the examples shown in FIGS. 1A-1B, 2, and 3A-3B may be used anywhere in one or more embodiments.

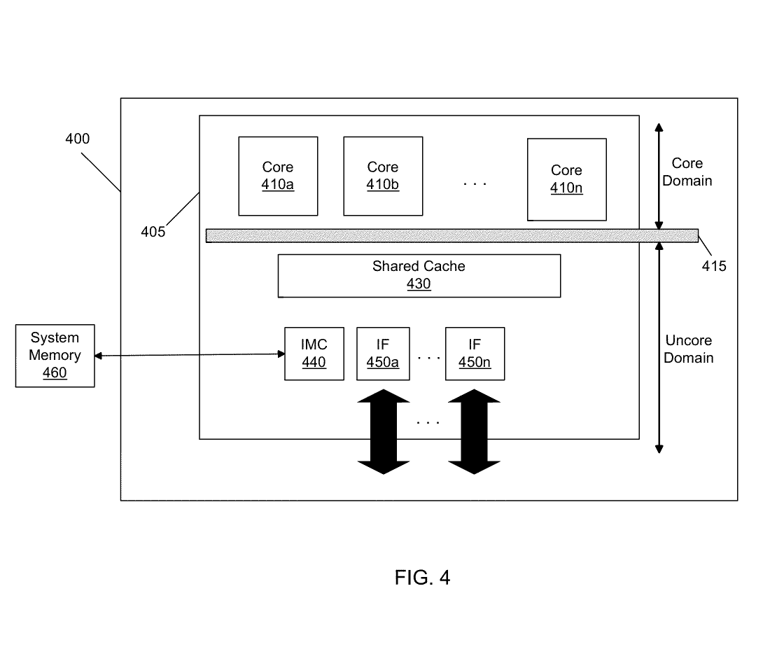

Referring now to FIG. 4, shown is a block diagram of a processor in accordance with an embodiment of the present invention. As shown in FIG. 4, the processor 400 may be a multicore processor including first die 405 having a plurality of cores 410a-410n of a core domain. The various cores 410a-410n may be coupled via an interconnect 415 to a system agent or uncore domain 420 that includes various components. As seen, the uncore domain 420 may include a shared cache 430 which may be a last level cache. In addition, the uncore may include an integrated memory controller 440 and various interfaces 450.

Although not shown for ease of illustration in FIG. 4, in some embodiments, each of the cores 410a-410n may include the prediction gating logic 120 shown in FIG. 1A. Alternatively, in some embodiments, some or all of the prediction gating logic 120 may be included in the uncore domain 420, and may thus be shared across the cores 410a-410n.

With further reference to FIG. 4, the processor 400 may communicate with a system memory 460, e.g., via a memory bus. In addition, by interfaces 450, connection can be made to various off-package components such as peripheral devices, mass storage and so forth. While shown with this particular implementation in the embodiment of FIG. 4, the scope of the present invention is not limited in this regard.

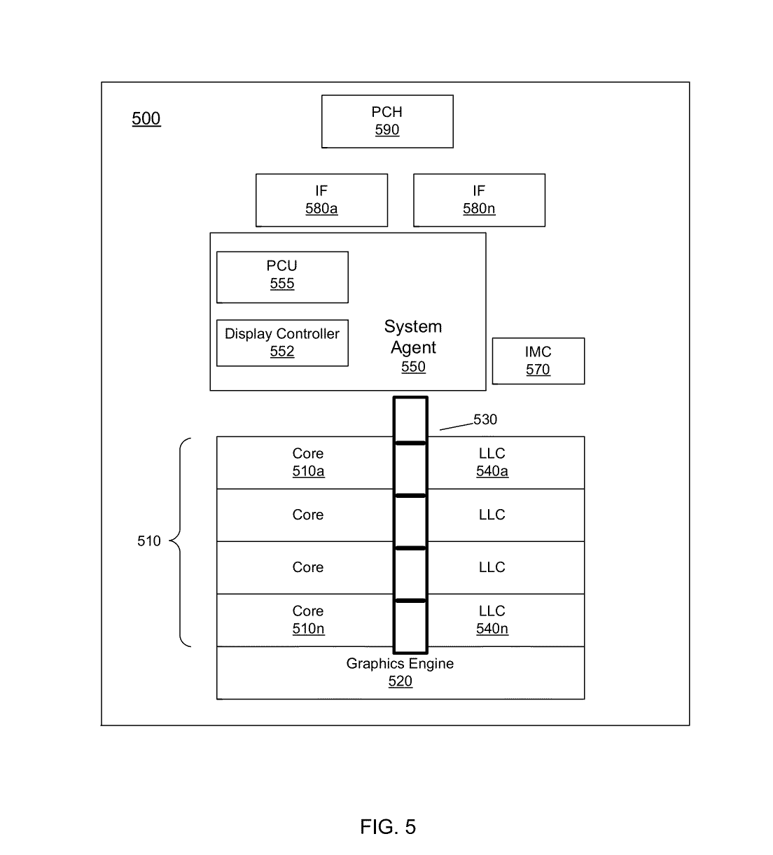

Referring now to FIG. 5, shown is a block diagram of a multi-domain processor in accordance with another embodiment of the present invention. As shown in the embodiment of FIG. 5, processor 500 includes multiple domains. Specifically, a core domain 510 can include a plurality of cores 510a-510n, a graphics domain 520 can include one or more graphics engines, and a system agent domain 550 may further be present. Although not shown for ease of illustration in FIG. 5, in some embodiments, each of the cores 510a-510n can include the prediction gating logic 120 described above with reference to FIG. 1A. Note that while only shown with three domains, understand the scope of the present invention is not limited in this regard and additional domains can be present in other embodiments. For example, multiple core domains may be present each including at least one core.

In general, each core 510 may further include low level caches in addition to various execution units and additional processing elements. In turn, the various cores may be coupled to each other and to a shared cache memory formed of a plurality of units of a last level cache (LLC) 540a-540n. In various embodiments, LLC 540 may be shared amongst the cores and the graphics engine, as well as various media processing circuitry. As seen, a ring interconnect 530 thus couples the cores together, and provides interconnection between the cores, graphics domain 520 and system agent circuitry 550. In the embodiment of FIG. 5, system agent domain 550 may include display controller 552 which may provide control of and an interface to an associated display. As further seen, system agent domain 550 may also include a power control unit 555 to allocate power to the CPU and non-CPU domains.

As further seen in FIG. 5, processor 500 can further include an integrated memory controller (IMC) 570 that can provide for an interface to a system memory, such as a dynamic random access memory (DRAM). Multiple interfaces 580a-580n may be present to enable interconnection between the processor and other circuitry. For example, in one embodiment at least one direct media interface (DMI) interface may be provided as well as one or more Peripheral Component Interconnect Express (PCI Express™ (PCIe™)) interfaces. Still further, to provide for communications between other agents such as additional processors or other circuitry, one or more interfaces in accordance with an Intel® Quick Path Interconnect (QPI) protocol may also be provided. As further seen, a peripheral controller hub (PCH) 590 may also be present within the processor, and can be implemented on a separate die, in some embodiments. Although shown at this high level in the embodiment of FIG. 5, understand the scope of the present invention is not limited in this regard.

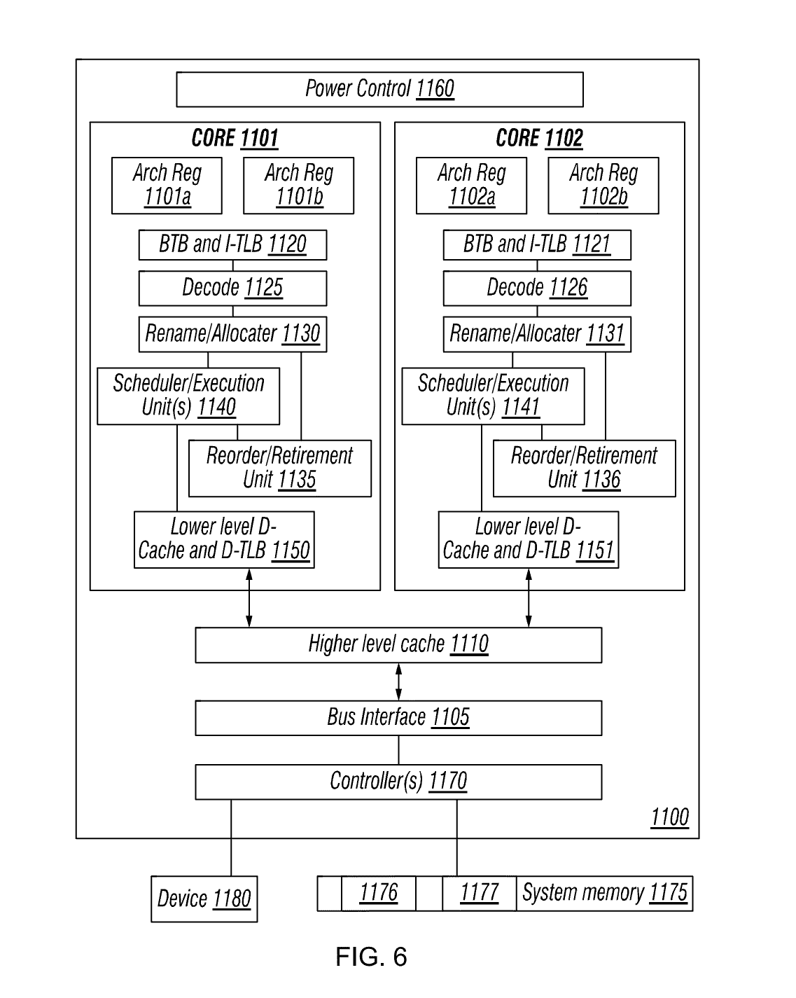

Referring to FIG. 6, an embodiment of a processor including multiple cores is illustrated. Processor 1100 includes any processor or processing device, such as a microprocessor, an embedded processor, a digital signal processor (DSP), a network processor, a handheld processor, an application processor, a co-processor, a system on a chip (SOC), or other device to execute code. Processor 1100, in one embodiment, includes at least two cores—cores 1101 and 1102, which may include asymmetric cores or symmetric cores (the illustrated embodiment). However, processor 1100 may include any number of processing elements that may be symmetric or asymmetric. Although not shown for ease of illustration in FIG. 6, in some embodiments, each of the cores 1101 and 1102 can include the prediction gating logic 120 described above with reference to FIG. 1A.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1100, as illustrated in FIG. 6, includes two cores, cores 1101 and 1102. Here, cores 1101 and 1102 are considered symmetric cores, i.e. cores with the same configurations, functional units, and/or logic. In another embodiment, core 1101 includes an out-of-order processor core, while core 1102 includes an in-order processor core. However, cores 1101 and 1102 may be individually selected from any type of core, such as a native core, a software managed core, a core adapted to execute a native instruction set architecture (ISA), a core adapted to execute a translated ISA, a co-designed core, or other known core. Yet to further the discussion, the functional units illustrated in core 1101 are described in further detail below, as the units in core 1102 operate in a similar manner.

As shown, core 1101 includes two hardware threads 1101a and 1101b, which may also be referred to as hardware thread slots 1101a and 1101b. Therefore, software entities, such as an operating system, in one embodiment potentially view processor 1100 as four separate processors, i.e., four logical processors or processing elements capable of executing four software threads concurrently. As alluded to above, a first thread is associated with architecture state registers 1101a, a second thread is associated with architecture state registers 1101b, a third thread may be associated with architecture state registers 1102a, and a fourth thread may be associated with architecture state registers 1102b. Here, each of the architecture state registers (1101a, 1101b, 1102a, and 1102b) may be referred to as processing elements, thread slots, or thread units, as described above.

As illustrated, architecture state registers 1101a are replicated in architecture state registers 1101b, so individual architecture states/contexts are capable of being stored for logical processor 1101a and logical processor 1101b. In core 1101, other smaller resources, such as instruction pointers and renaming logic in allocator and renamer block 1130 may also be replicated for threads 1101a and 1101b. Some resources, such as re-order buffers in reorder/retirement unit 1135, ILTB 1120, load/store buffers, and queues may be shared through partitioning. Other resources, such as general purpose internal registers, page-table base register(s), low-level data-cache and data-TLB 1115, execution unit(s) 1140, and portions of out-of-order unit 1135 are potentially fully shared.

Processor 1100 often includes other resources, which may be fully shared, shared through partitioning, or dedicated by/to processing elements. In FIG. 6, an embodiment of a purely exemplary processor with illustrative logical units/resources of a processor is illustrated. Note that a processor may include, or omit, any of these functional units, as well as include any other known functional units, logic, or firmware not depicted. As illustrated, core 1101 includes a simplified, representative out-of-order (OOO) processor core. But an in-order processor may be utilized in different embodiments. The OOO core includes a branch target buffer 1120 to predict branches to be executed/taken and an instruction-translation buffer (I-TLB) 1120 to store address translation entries for instructions.

Core 1101 further includes decode module 1125 coupled to fetch unit 1120 to decode fetched elements. Fetch logic, in one embodiment, includes individual sequencers associated with thread slots 1101a, 1101b, respectively. Usually core 1101 is associated with a first ISA, which defines/specifies instructions executable on processor 1100. Often machine code instructions that are part of the first ISA include a portion of the instruction (referred to as an opcode), which references/specifies an instruction or operation to be performed. Decode logic 1125 includes circuitry that recognizes these instructions from their opcodes and passes the decoded instructions on in the pipeline for processing as defined by the first ISA. As a result of the recognition by decoders 1125, the architecture or core 1101 takes specific, predefined actions to perform tasks associated with the appropriate instruction (e.g., the actions shown in FIGS. 3A-3B). It is important to note that any of the tasks, blocks, operations, and methods described herein may be performed in response to a single or multiple instructions; some of which may be new or old instructions.

In one example, allocator and renamer block 1130 includes an allocator to reserve resources, such as register files to store instruction processing results. However, threads 1101a and 1101b are potentially capable of out-of-order execution, where allocator and renamer block 1130 also reserves other resources, such as reorder buffers to track instruction results. Unit 1130 may also include a register renamer to rename program/instruction reference registers to other registers internal to processor 1100. Reorder/retirement unit 1135 includes components, such as the reorder buffers mentioned above, load buffers, and store buffers, to support out-of-order execution and later in-order retirement of instructions executed out-of-order.

Scheduler and execution unit(s) block 1140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1150 are coupled to execution unit(s) 1140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1101 and 1102 share access to higher-level or further-out cache 1110, which is to cache recently fetched elements. Note that higher-level or further-out refers to cache levels increasing or getting further away from the execution unit(s). In one embodiment, higher-level cache 1110 is a last-level data cache—last cache in the memory hierarchy on processor 1100—such as a second or third level data cache. However, higher level cache 1110 is not so limited, as it may be associated with or includes an instruction cache. A trace cache—a type of instruction cache—instead may be coupled after decoder 1125 to store recently decoded traces.

In the depicted configuration, processor 1100 also includes bus interface module 1105 and a power controller 1160, which may perform power sharing control in accordance with an embodiment of the present invention. Historically, controller 1170 has been included in a computing system external to processor 1100. In this scenario, bus interface 1105 is to communicate with devices external to processor 1100, such as system memory 1175, a chipset (often including a memory controller hub to connect to memory 1175 and an I/O controller hub to connect peripheral devices), a memory controller hub, a northbridge, or other integrated circuit. And in this scenario, bus 1105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1175 may be dedicated to processor 1100 or shared with other devices in a system. Common examples of types of memory 1175 include DRAM, SRAM, non-volatile memory (NV memory), and other known storage devices. Note that device 1180 may include a graphic accelerator, processor or card coupled to a memory controller hub, data storage coupled to an I/O controller hub, a wireless transceiver, a flash device, an audio controller, a network controller, or other known device.

Note however, that in the depicted embodiment, the controller 1170 is illustrated as part of processor 1100. Recently, as more logic and devices are being integrated on a single die, such as SOC, each of these devices may be incorporated on processor 1100. For example in one embodiment, memory controller hub 1170 is on the same package and/or die with processor 1100. Here, a portion of the core (an on-core portion) includes one or more controller(s) 1170 for interfacing with other devices such as memory 1175 or a graphics device 1180. The configuration including an interconnect and controllers for interfacing with such devices is often referred to as an on-core (or un-core configuration). As an example, bus interface 1105 includes a ring interconnect with a memory controller for interfacing with memory 1175 and a graphics controller for interfacing with graphics processor 1180. Yet, in the SOC environment, even more devices, such as the network interface, co-processors, memory 1175, graphics processor 1180, and any other known computer devices/interface may be integrated on a single die or integrated circuit to provide small form factor with high functionality and low power consumption.

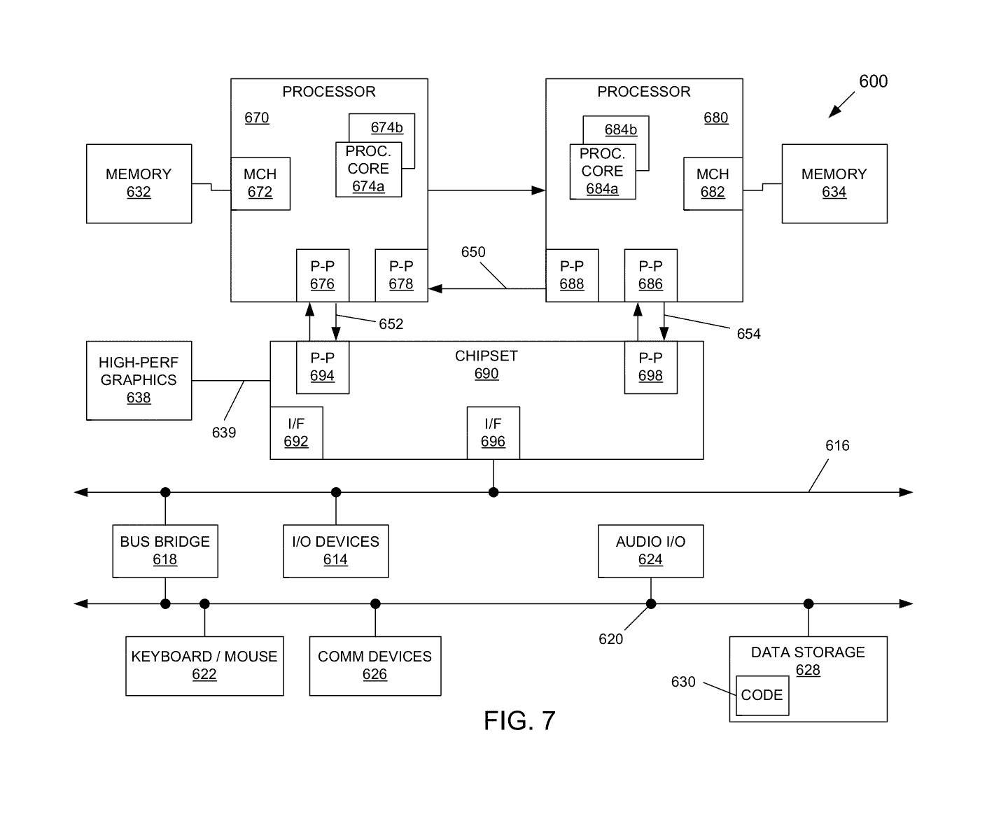

Embodiments may be implemented in many different system types. Referring now to FIG. 7, shown is a block diagram of a system in accordance with an embodiment of the present invention. As shown in FIG. 7, multiprocessor system 600 is a point-to-point interconnect system, and includes a first processor 670 and a second processor 680 coupled via a point-to-point interconnect 650. As shown in FIG. 7, each of processors 670 and 680 may be multicore processors, including first and second processor cores (i.e., processor cores 674a and 674b and processor cores 684a and 684b), although potentially many more cores may be present in the processors. Each of these processors can include the prediction gating logic 120 described above with reference to FIG. 1A.

Still referring to FIG. 7, first processor 670 further includes a memory controller hub (MCH) 672 and point-to-point (P-P) interfaces 676 and 678. Similarly, second processor 680 includes a MCH 682 and P-P interfaces 686 and 688. As shown in FIG. 7, MCH's 672 and 682 couple the processors to respective memories, namely a memory 632 and a memory 634, which may be portions of system memory (e.g., DRAM) locally attached to the respective processors. First processor 670 and second processor 680 may be coupled to a chipset 690 via P-P interconnects 652 and 654, respectively. As shown in FIG. 7, chipset 690 includes P-P interfaces 694 and 698.

Furthermore, chipset 690 includes an interface 692 to couple chipset 690 with a high performance graphics engine 638, by a P-P interconnect 639. In turn, chipset 690 may be coupled to a first bus 616 via an interface 696. As shown in FIG. 7, various input/output (I/O) devices 614 may be coupled to first bus 616, along with a bus bridge 618 which couples first bus 616 to a second bus 620. Various devices may be coupled to second bus 620 including, for example, a keyboard/mouse 622, communication devices 626 and a data storage unit 628 such as a disk drive or other mass storage device which may include code 630, in one embodiment. Further, an audio I/O 624 may be coupled to second bus 620. Embodiments can be incorporated into other types of systems including mobile devices such as a smart cellular telephone, tablet computer, netbook, Ultrabook™, or so forth.

It should be understood that a processor core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

Any processor described herein may be a general-purpose processor, such as a Core™ i3, i5, i7, 2 Duo and Quad, Xeon™, Itanium™, XScale™ or StrongARM™ processor, which are available from Intel Corporation, of Santa Clara, Calif. Alternatively, the processor may be from another company, such as ARM Holdings, Ltd, MIPS, etc. The processor may be a special-purpose processor, such as, for example, a network or communication processor, compression engine, graphics processor, co-processor, embedded processor, or the like. The processor may be implemented on one or more chips. The processor may be a part of and/or may be implemented on one or more substrates using any of a number of process technologies, such as, for example, BiCMOS, CMOS, or NMOS.

It is contemplated that the processors described herein are not limited to any system or device. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The following clauses and/or examples pertain to further embodiments. One example embodiment may be a processor including at least one execution unit and prediction gating logic. The prediction gating logic may be to: in response to a first prediction that a first branch is taken, obtain a distance value to a second branch using a target array; and gate a branch prediction unit for a number of instruction blocks equal to the distance value to the second branch. The prediction gating logic may be further to: set a halt counter equal to the distance value; and decrement the halt counter for each of the number of instruction blocks. The branch prediction unit may be to generate a prediction for the second branch when the halt counter is equal to zero. The prediction gating logic may be to determine a preferred component of the branch prediction unit based on the target array, where the branch prediction unit is to generate the prediction for the second branch using the preferred component. The processor may also include a fetch unit to fetch each of the number of instruction blocks. The prediction gating logic may be to obtain the distance value based on a distance portion of a first entry of the target array, wherein the first entry comprises a tag for the first branch. The distance value may be a multiple of a value of the distance portion of the first entry. The processor may also include a decoder to: in response to a second prediction that the first branch is taken, increment a distance counter for each instruction block until a second branch is predicted taken, and store a value of the distance counter in the distance portion of the first entry, where the second prediction occurs prior to the first prediction. The decoder may include a register to store a tag for the first branch.

Another example embodiment may be a system including a processor, and a memory coupled to the processor. The processor may be to: in response to a first prediction that a first branch is taken, obtain a distance value to a second branch using a target array; set a halt counter equal to the distance value; for each instruction block after the first branch, decrement the halt counter, and process the instruction block, without using a branch prediction unit, when the halt counter is greater than zero. The branch prediction unit may be to generate a prediction for a second branch when the halt counter is equal to zero. The branch prediction unit may be to generate the prediction for the second branch processor using a preferred component of the branch prediction unit. The processor may be to identify the preferred component based on a preferred component portion of a first entry of the target array. The processor may be to obtain the distance value by decoding a distance portion of a first entry of the target array, wherein the first entry is associated with the first branch. The processor may be further to, during a training phase: determine, using a distance counter, a number of blocks between the first branch and the second branch; and encode the number of blocks in the distance portion of the first entry of the target array. The processor may be to, during the training phase, encode the number of blocks by removing one or more bits of a bit value of the number of blocks. The processor may be to, during the training phase, store a preferred component identifier in a preferred component portion of the first entry of the target array.

Yet another example embodiment may be a method, including: predicting, by a branch prediction unit of a processor, that a first branch is taken; determining a distance value to a second branch based on a target array; setting a halt counter equal to the distance value; decrementing the halt counter for each instruction block; and gating the branch prediction unit until the halt counter reaches a first value. The method may also include generating a prediction for a second branch when the halt counter reaches the first value. Determining the distance value may include decoding a distance portion of a first entry of the target array. The first entry of the target array may include a tag identifier for the first branch. The method may also include updating the distance portion of the first entry when the second branch is predicted not taken.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments for the sake of illustration, those skilled in the art will appreciate numerous modifications and variations therefrom. It is intended that the appended claims cover all such modifications and variations as fall within the true spirit and scope of this present invention.

What is claimed is:

1. A processor comprising:
at least one execution unit; and
prediction gating logic coupled to the at least one execution unit, the prediction gating logic to:
in response to a first prediction that a first branch is taken, obtain a distance value to a second branch using a target array; and
gate a branch prediction unit for a number of instruction blocks equal to the distance value to the second branch.

2. The processor of claim 1, wherein the prediction gating logic is further to:
set a halt counter equal to the distance value; and
decrement the halt counter for each of the number of instruction blocks.

3. The processor of claim 2, wherein the branch prediction unit is to generate a prediction for the second branch when the halt counter is equal to zero.

4. The processor of claim 3, wherein the prediction gating logic is to determine a preferred component of the branch prediction unit based on the target array, and wherein the branch prediction unit is to generate the prediction for the second branch using the preferred component.

5. The processor of claim 2, further comprising a fetch unit to fetch each of the number of instruction blocks.

6. The processor of claim 1, wherein the prediction gating logic is to obtain the distance value based on a distance portion of a first entry of the target array, wherein the first entry comprises a tag for the first branch.

7. The processor of claim 6, wherein the distance value is a multiple of a value of the distance portion of the first entry.

8. The processor of claim 6, further comprising a decoder to:
in response to a second prediction that the first branch is taken, increment a distance counter for each instruction block until a second branch is predicted taken, and
store a value of the distance counter in the distance portion of the first entry,
wherein the second prediction occurs prior to the first prediction.

9. The processor of claim 8, wherein the decoder comprises a register to store a tag for the first branch.

10. A system comprising:
a processor to:
in response to a first prediction that a first branch is taken, obtain a distance value to a second branch using a target array;
set a halt counter equal to the distance value;
for each instruction block after the first branch:
decrement the halt counter;
process the instruction block, without using a branch prediction unit, when the halt counter is greater than zero; and
a memory coupled to the processor.

11. The system of claim 10, wherein the branch prediction unit is to generate a prediction for a second branch when the halt counter is equal to zero.

12. The system of claim 11, wherein the branch prediction unit is to generate the prediction for the second branch processor using a preferred component of the branch prediction unit.

13. The system of claim 12, wherein the processor is to identify the preferred component based on a preferred component portion of a first entry of the target array.

14. The system of claim 10, wherein the processor is to obtain the distance value by decoding a distance portion of a first entry of the target array, wherein the first entry is associated with the first branch.

15. The system of claim 14, wherein the processor is further to, during a training phase:
determine, using a distance counter, a number of blocks between the first branch and the second branch; and
encode the number of blocks in the distance portion of the first entry of the target array.

16. The system of claim 15, wherein the processor is to, during the training phase, encode the number of blocks by removing one or more bits of a bit value of the number of blocks.

17. The system of claim 15, wherein the processor is to, during the training phase, store a preferred component identifier in a preferred component portion of the first entry of the target array.

18. A method, comprising:
predicting, by a branch prediction unit of a processor, that a first branch is taken;
determining a distance value to a second branch based on a target array;
setting a halt counter equal to the distance value;
decrementing the halt counter for each instruction block; and
gating the branch prediction unit until the halt counter reaches a first value.

19. The method of claim 18, further comprising generating a prediction for a second branch when the halt counter reaches the first value.

20. The method of claim 18, wherein determining the distance value comprises decoding a distance portion of a first entry of the target array.

21. The method of claim 20, wherein the first entry of the target array comprises a tag identifier for the first branch.

22. The method of claim 20, further comprising updating the distance portion of the first entry when the second branch is predicted not taken.
